(19) United States
(12) Patent Application Publication
(10) Pub. No.: US 2026/0140562 A1
(43) Pub. Date: May 21, 2026

(54) SEMICONDUCTOR INTEGRATED CIRCUIT DEVICE AND POWER CUTOFF METHOD FOR CIRCUIT MODULE IN SEMICONDUCTOR INTEGRATED CIRCUIT DEVICE

(71) Applicant: MegaChips Corporation, Osaka (JP)

(72) Inventor: Seiji Takenobu, Osaka (JP)

(73) Assignee: MegaChips Corporation, Osaka (JP)

(21) Appl. No.: 19/359,146

(22) Filed: Oct. 15, 2025

(30) Foreign Application Priority Data
Nov. 20, 2024 (JP) 2024-202489

(51) Int. Cl. G06F 1/3234

(52) U.S. Cl. CPC G06F 1/3253

(57) ABSTRACT

The present invention provides a semiconductor integrated circuit device which includes a bus, a processor circuit module, and a circuit module targeted for power cutoff. The bus includes a bus core including a data signal line, and a predetermined bus interface circuit configured to connect the circuit module to the bus core. The predetermined bus interface circuit includes a transaction control circuit configured to control transactions for data transmission via the bus core, and a power supply control circuit including a power supply control register and configured to perform power supply control for the circuit module in accordance with a register value stored in the power supply control register. The power supply control circuit performs control to cut off power supply to the circuit module in response to a power cutoff instruction from the transaction control circuit under control of the processor circuit module.

### CROSS REFERENCE TO RELATED APPLICATIONS AND INCORPORATION BY REFERENCE

This application claims benefit of priority under 35 U.S.C. § 119 based on Japanese Patent Application No. 2024-202489 filed on Nov. 20, 2024, the entire contents of which are incorporated by reference herein.

### TECHNICAL FIELD

The present invention relates to a semiconductor integrated circuit device and a power cutoff method for a circuit module in a semiconductor integrated circuit device.

### BACKGROUND ART

As semiconductor integrated circuit devices become more highly integrated (hierarchical structuring and/or miniaturization of process rules), power consumption increases, and an increase in leak current and an increase in switching electric power present a serious problem. In view of this, in order to deal with such a power problem, power cutoff technology (also referred to as “power gating technology”) that suppresses power consumption by dynamically cutting off power supply to a circuit block that is not used in the semiconductor integrated circuit device has been known. In the power cutoff technology, a certain type of control circuit called a power management unit (PMU) for controlling power supply to the circuit block is provided in the semiconductor integrated circuit device.

For example, JP 2010-245414 A (“Patent Document 1”) discloses a semiconductor integrated circuit device including a power cutoff switch. More specifically, the semiconductor integrated circuit device of Patent Document 1 includes a circuit block targeted for power cutoff, a circuit block including, for example, a CPU, a power cutoff control circuit, and related components that continuously operate upon receipt of power, and a power cutoff switch configured to selectively enable and disable power supply to the circuit block targeted for power cutoff. The power cutoff control circuit is controlled by the CPU and controls the power cutoff switch by outputting a necessary voltage to the power cutoff switch in accordance with the operation timing of the circuit block targeted for power cutoff.

The circuit block to which power supply is cut off by the power cutoff technology operates unintentionally and generates wrong signals due to signals flowing from its adjacent circuit block in operation, which causes such a problem that the wrong signals flow into the adjacent circuit block in operation. In particular, inrush current (transient current) induced by a restoration operation following power cutoff may affect the operation of the semiconductor integrated circuit device. Accordingly, generally, in order that the circuit block in a power-off state does not interfere with the circuit block in operation, an isolator (also referred to as an isolation cell) is provided around the circuit block targeted for power cutoff.

For example, JP 2012-008093 A (“Patent Document 2”) discloses a semiconductor integrated circuit (LSI) including an isolation cell configured to fix the output from a given circuit region (domain) when power supply to the given circuit region is cut off. More specifically, in the LSI of Patent Document 2, the internal state of the LSI can be set to a desired condition via a scan chain implemented within the LSI, and when power supply to the domain is about to stop, a PMU asserts a signal to be input to the isolation cell and fixes the output of the domain.

### SUMMARY OF INVENTION

### Technical Problem

In the application of the power cutoff technology to the semiconductor integrated circuit device, it is necessary that the PMU be arranged appropriately in the semiconductor integrated circuit device and a signal line be arranged appropriately between the PMU and a circuit block or module targeted for power cutoff (hereinafter referred to as a “power cutoff target circuit module”). Accordingly, as semiconductor integrated circuit devices become more highly integrated, the number of power cutoff target circuit modules also increases, therefore affecting the effective core area.

In a layout design such as disposition of the PMU or wiring, the increasing integration density of semiconductor integrated circuit devices prolongs the time required for simulations using circuit models, which leads to problems of an increase in man-hours for development and an increase in costs incurred as a result. Among other things, the problem of inrush current induced by restoration of power supply to the power cutoff target circuit module requires resolution through repeated design iterations. In addition, design modification or the like of some circuit modules may affect the behavior of adjacent power cutoff target circuit modules, and it is difficult to suppress the man-hours and costs for development. Besides, there is such a problem that, in a case where unexpected defects are detected due to insufficient simulation accuracy or the like after transitioning to a die's physical fabrication stage following simulation, significant loss occurs for a development process. This means that it takes a huge amount of time in a hardware design phase to minimize the risk of hardware design errors as much as possible.

In addition, the PMU itself in the semiconductor integrated circuit device does not participate in a data transfer process (transaction) through a bus (BUS) by the power cutoff target circuit module, and the CPU checks the transaction state of a bus interface circuit (hereinafter referred to as a “bus IF circuit”) to the power cutoff target circuit module and controls the PMU. This requires control flows for signal exchanges between the CPU and the bus IF circuit via the bus and signal exchanges between the CPU and the PMU via the bus, which affects the performance of the whole semiconductor integrated circuit device.

Further, isolation cells are designed to fix the output voltage to High or Low to suppress the occurrence of inrush current induced by the restoration operation after power cutoff. The isolation cells are designed for the purpose of suppressing the occurrence of inrush current and thus are not intended to be used for other purposes at present.

In view of this, an object of the present invention is to propose a new architecture for a semiconductor integrated circuit device to which the power cutoff technology is applied.

More specifically, one object of the present invention is to provide a semiconductor integrated circuit device that enables power cutoff without a power management unit (PMU) conventionally provided for power supply control for a power cutoff target circuit module in the semiconductor integrated circuit device, and a power cutoff method for the semiconductor integrated circuit device.

Another object of the present invention is to provide a semiconductor integrated circuit device that can suppress the influence of inrush current in power supply control for a power cutoff target circuit module in the semiconductor integrated circuit device, and a power cutoff method for the semiconductor integrated circuit device.

Further another object of the present invention is to provide a semiconductor integrated circuit device that enables signal control for other circuit blocks by a power cutoff target circuit module even while power supply to the power cutoff target circuit module in the semiconductor integrated circuit device is cut off, and a power cutoff method for the semiconductor integrated circuit device.

Still further another object of the present invention is to provide a semiconductor integrated circuit device that can reduce man-hours for development of the semiconductor integrated circuit device to which the power cutoff technology is applied and which can also suppress development costs incurred as a result, and a power cutoff method for the semiconductor integrated circuit device.

### Solution to Problem

The present invention to achieve the above objects includes invention-defining matters and technical features described below.

One aspect of the present invention provides a semiconductor integrated circuit device including a bus, a processor circuit module, and a predetermined circuit module targeted for power cutoff. The bus includes a bus core including a data signal line, and a predetermined bus interface circuit configured to connect the predetermined circuit module to the bus core. The predetermined bus interface circuit includes a transaction control circuit configured to control transactions for data transmission via the bus core, and a power supply control circuit including a power supply control register and configured to perform power supply control for the predetermined circuit module in accordance with a register value stored in the power supply control register. The power supply control circuit performs control to cut off power supply to the predetermined circuit module in response to a power cutoff instruction from the transaction control circuit under control of the processor circuit module.

The semiconductor integrated circuit device may further include a bus interface circuit different from the predetermined bus interface and configured to connect a circuit module not targeted for power cutoff (a continuously-energized circuit module) to the bus core. In this disclosure, the circuit module not targeted for power cutoff is referred to as a first circuit module, and the circuit module targeted for power cutoff is referred to as a second circuit module.

The transaction control circuit may provide the power cutoff instruction to the power supply control circuit in response to a power cutoff instruction set from the processor circuit module.

The semiconductor integrated circuit device may further include a power supply switch unit including at least one switching element configured to selectively switch between power supply and power cutoff to the predetermined circuit module.

The power supply control circuit may control the at least one switching element to selectively switch between power supply and power cutoff in accordance with the register value stored in the power supply control register.

The power supply switch unit may include a plurality of switching elements as the at least one switching element, and a selector configured to divide the plurality of switching elements into first switching elements as a first group and second switching elements as a second group.

The power supply control circuit may control the selector in accordance with the register value such that the first switching elements and the second switching elements operate in parallel.

The power supply control circuit may control the selector in accordance with the register value such that the first switching elements and the second switching elements operate sequentially with a predetermined offset time.

The power supply control register may be configured to rewrite the register value.

The semiconductor integrated circuit device may further include an isolation region provided to surround at least part of the predetermined circuit module. The isolation region may include at least one isolation cell configured to output a predetermined data signal externally under control of the power supply control circuit.

In a case where the power supply control circuit performs control to cut off power supply to the predetermined circuit module, the power supply control circuit may control the at least one isolation cell to output the predetermined data signal in synchronization with a predetermined clock signal.

Another aspect of the present invention provides a power cutoff method for cutting off power supply to a predetermined circuit module targeted for power cutoff in a semiconductor integrated circuit device. The power cutoff method includes receiving a power cutoff instruction set from a processor circuit module via a bus under control of a bus interface circuit configured to connect the predetermined circuit module to the bus, and performing control to cut off power supply to the predetermined circuit module in accordance with a register value of a power supply control register, in response to completion of transaction processing for the predetermined circuit module.

The power cutoff method may further include causing, under control of the bus interface circuit, an isolation cell in an isolation region formed around the predetermined circuit module to output a predetermined output signal in accordance with the register value while cutting off the power supply.

It is noted that, in the present specification, the term “means” does not merely indicate physical means but also includes a case where the function of the means is implemented by software. The function of a single means may be implemented by two or more physical means, and conversely, the functions of two or more means may be implemented by a single physical means. The term “system” refers to a logical aggregation of multiple devices (or functional modules configured to implement specific functions), and it is not essential whether the individual devices or functional modules are housed within a single enclosure.

The functions of the elements disclosed herein may be implemented using a general-purpose processor, a dedicated processor, an integrated circuit, an ASIC (application-specific integrated circuit), a conventional circuit configuration, each configured or programmed to execute the disclosed functions, and/or a circuit configuration including a combination of any of them, or a processing circuit configuration. A processor, when including transistors and other circuit components therein, may be regarded as a processing circuit configuration or circuit configuration. In this disclosure, the circuit configuration, unit, or means refers to hardware that executes the stated functions, or hardware programmed to execute the functions. The hardware may be any other known hardware that is programmed or configured to execute the functions disclosed or described herein. When the hardware is a processor that may be regarded as a type of circuit configuration, the circuit configuration, means, or unit may include a combination of hardware and software, and the software is used to configure the hardware and/or the processor.

### Advantageous Effects of Invention

The present invention provides a new architecture for a semiconductor integrated circuit device to which power cutoff technology is applied. Particularly, with the present invention, it is possible to cut off and restore power supply to a power cutoff target circuit module even when the semiconductor integrated circuit device does not include an individual power management unit (PMU) for power supply control for the power cutoff target circuit module.

With the present invention, it is possible to suppress the influence of inrush current in the power supply control for the power cutoff target circuit module in the semiconductor integrated circuit device.

The present invention enables signal control for other circuit blocks by an isolation cell of the power cutoff target circuit module even while power supply to the power cutoff target circuit module in the semiconductor integrated circuit device is cut off.

With the present invention, it is possible to reduce man-hours for development of the semiconductor integrated circuit device to which the power cutoff technology is applied and to suppress development costs incurred as a result.

Other technical features, objects, and effects or advantages of the present invention will become apparent from the following embodiments, which are described with reference to the accompanying drawings. The effects described in the present specification are just examples and are not limitative, and the present invention may achieve other effects.

### BRIEF DESCRIPTION OF DRAWINGS

FIG. 1 is a view to describe an example of a schematic configuration of a semiconductor integrated circuit device according to one embodiment of the present invention.

FIG. 2 is a view illustrating a schematic configuration of a bus interface circuit in the semiconductor integrated circuit device according to one embodiment of the present invention.

FIG. 3 is a view to describe power supply control for a second circuit module by the bus interface circuit in the semiconductor integrated circuit device according to one embodiment of the present invention.

FIG. 4 is a view illustrating an exemplary configuration of power supply switch units of the second circuit module in the semiconductor integrated circuit device according to one embodiment of the present invention.

FIG. 5 is a view to describe control for an isolation region by the bus interface circuit in the semiconductor integrated circuit device according to one embodiment of the present invention.

FIG. 6 is a view illustrating an example of data signals output from an isolation cell in the semiconductor integrated circuit device according to one embodiment of the present invention.

FIG. 7 is a flowchart to describe an example of the operation of the bus interface circuit in the semiconductor integrated circuit device according to one embodiment of the present invention.

### DESCRIPTION OF EMBODIMENTS

With reference to the drawings, the following describes an embodiment of the present invention. Note that the embodiment described below is just an example and is not intended to exclude various modifications and applications of the technology, which are not clearly mentioned below. The present invention can be performed with various modifications (for example, combinations of embodiments) without departing from the gist of the present invention. In the drawings to be referred to in the following description, identical or similar portions have identical or similar reference signs. The drawings are schematic and do not necessarily correspond with actual dimensions, ratios, or the like. The drawings may include portions having different dimensional relationships or ratios.

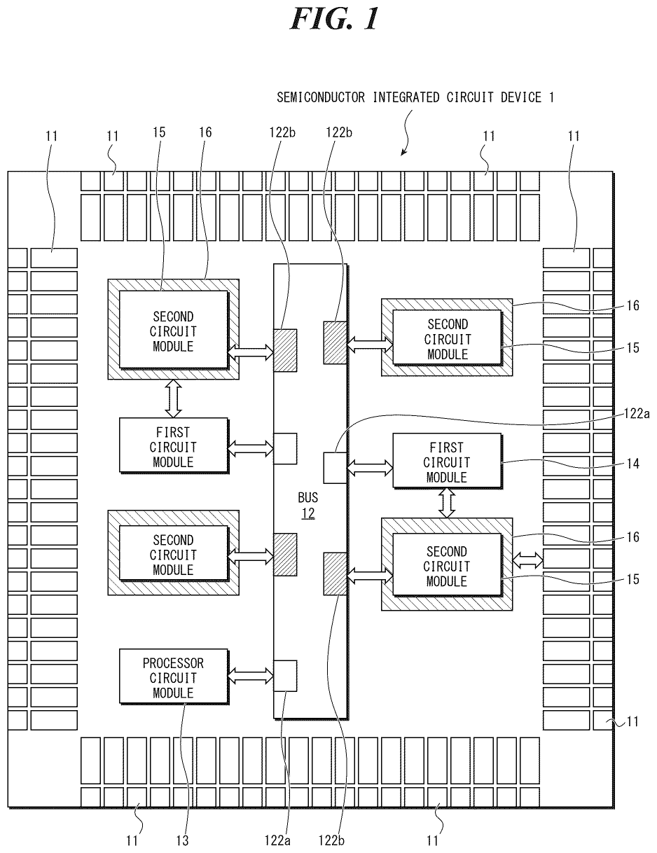

FIG. 1 is a view to describe an example of a schematic configuration of a semiconductor integrated circuit device according to one embodiment of the present invention. As illustrated in FIG. 1, a semiconductor integrated circuit device 1 according to the present embodiment is a system on a chip (SoC), in which a plurality of electrode pads 11 for connecting bonding wires is arranged at the periphery, for example. The semiconductor integrated circuit device 1 includes, for example, a processor circuit module 13, first circuit modules 14, and second circuit modules 15, which are connected to each other via a bus 12. The semiconductor integrated circuit device 1 further includes an isolation region 16 formed around at least part of each of the second circuit modules 15.

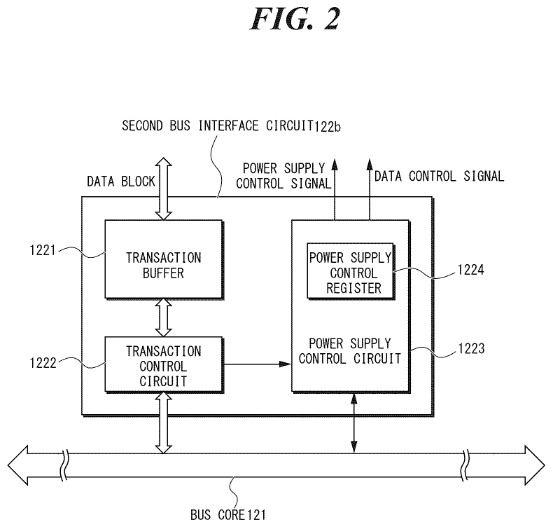

The bus 12 is a transmission circuit which enables data transmission between various circuit modules 13 to 15. The bus 12 includes, for example, a bus core 121 and bus interface circuits (hereinafter referred to as “bus IF circuits”) 122 (see FIG. 2). The bus core 121 includes a data signal line to transmit data. The bus IF circuits 122 are provided to correspond to respective circuit modules. The bus IF circuit 122 comprehensively controls the timing to send data blocks of its corresponding circuit module to the bus core 121 and the timing to acquire data blocks on the bus core 121. The bus IF circuits 122 in this disclosure include first bus IF circuits 122a and second bus IF circuits 122b. In this disclosure, as will be described later, the first bus IF circuits 122a and the second bus IF circuits 122b have different configurations. Although not illustrated herein, the bus 12 can include a DMA (Direct Memory Access) control circuit.

The first bus IF circuits 122a are provided for the processor circuit module 13 and the first circuit module 14. The first bus IF circuit 122a includes, for example, a transaction buffer 1221 and a transaction control circuit 1222 (see FIG. 2). The configuration of a conventional bus IF circuit can be applied to the first bus IF circuit 122a, but the first bus IF circuit 122a is not limited to this.

The second bus IF circuits 122b are provided for the second circuit modules 15. The second bus IF circuit 122b includes, for example, a power supply control circuit 1223, in addition to the transaction buffer 1221 and the transaction control circuit 1222 (see FIG. 2). The power supply control circuit 1223 is a circuit configured to control power supply and power cutoff to its corresponding second circuit module 15 (described later). Since the power supply control circuit 1223 is provided in the second bus IF circuit 122b for each second circuit module, a wiring line from a PMU to a power cutoff target circuit module becomes unnecessary unlike the related art, thereby making it possible to reduce working hours for a layout process required due wiring congestion.

The processor circuit module 13 is a circuit configured to interpret and execute a predetermined program to process various types of data. The processor circuit module 13 is embodied as a CPU or MPU. The processor circuit module 13 may have a multiprocessor configuration. The processor circuit module 13 comprehensively controls the bus 12. For example, the processor circuit module 13 may control, via the bus 12, the operation of a particular circuit module (i.e., the first circuit module 14 and/or the second circuit module 15) in accordance with a predetermined program execution. In this disclosure, the processor circuit module 13 instructs the power supply control circuit 1223 of the second bus IF circuit 122b to execute power supply control for a particular second circuit module 15.

The first circuit module 14 is a circuit module to be maintained in an energized state, supplied continuously with electric power from a power source (not illustrated), during operation of the semiconductor integrated circuit device 1. In this disclosure, such a circuit module that is continuously maintained in the energized state may be referred to as a continuously-energized circuit module. For example, the first circuit module 14 is embodied as a SRAM under constant access or a small-scaled and low-speed circuit module with low power reduction efficiency. The first circuit module 14 is connected to the bus core 121 via the first bus IF circuit 122a.

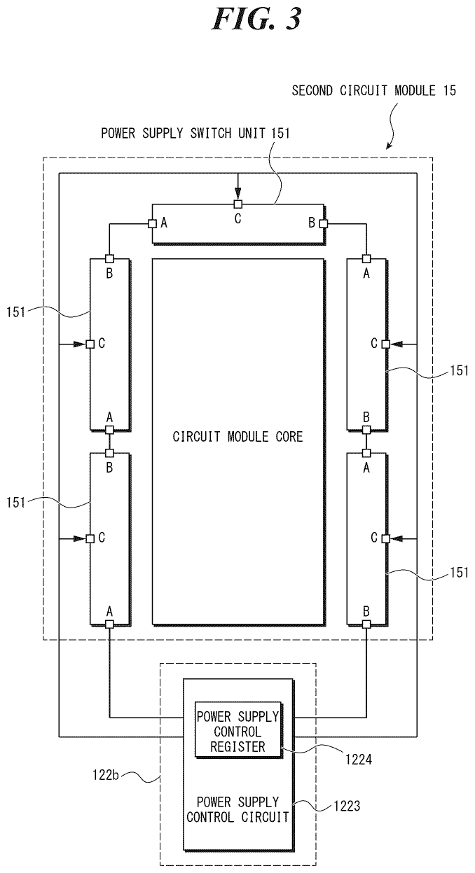

The second circuit module 15 is a circuit module to be supplied with electric power from the power source during execution of processing, and to be cut off from the power source in the absence of executable processing, under the control of the processor circuit module 13, during operation of the semiconductor integrated circuit device 1. In this disclosure, such a circuit module to which power supply can be cut off may be referred to as a power cutoff target circuit module. For example, the second circuit module 15 is embodied as an image processing module configured to execute a resizing process, a defect pixel correction process, a shading correction process, a color space conversion process, and other processes on images. In a case where no image data to be processed is input, the image processing module does not need to operate and therefore can be targeted for power cutoff. The second circuit module 15 includes power supply switch units 151 (see FIG. 3). The power supply switch unit 151 is a switching circuit which includes one or more switching elements 1511 configured to selectively switch between power supply and power cutoff under the control of the power supply control circuit 1223. The power supply switch unit 151 may be formed as part of the second circuit module 15 or may be formed around the second circuit module 15. The second circuit module 15 is connected to the bus core 121 via the second bus IF circuit 122b. The second circuit module 15 is controlled by the power supply control circuit 1223 of the second bus IF circuit 122b to switch between power supply and power cutoff, under the control of the processor circuit module 13. That is, in a case where power supply to a given second circuit module 15 is cut off, its corresponding power supply control circuit 1223 confirms that the given second circuit module does not access the bus 12 and then performs control to cut off power supply to the given second circuit module.

The isolation region 16 is a region formed around the second circuit module 15 to cut off signals from entering the second circuit module 15 and/or to control signals to be output from the second circuit module 15. The isolation region 16 includes a logic circuit, for example. The isolation region 16 is configured to output a bit signal represented by a predetermined alternating volage (for example, a high voltage or a low voltage) while power supply to the second circuit module 15 is cut off. For example, the isolation region 16 may output a predetermined enable signal, a predetermined clock signal, a predetermined data signal, or the like under the control of the power supply control circuit 1223.

FIG. 2 is a view illustrating an example of a schematic configuration of the bus interface circuit in the semiconductor integrated circuit device according to one embodiment of the present invention. More specifically, FIG. 2 illustrates a functional configuration model of the second bus IF circuit 122b connected to the second circuit module 15, serving as the power cutoff target circuit module. As mentioned earlier, the second bus IF circuit 122b is different from the first bus IF circuit 122a in that the second bus IF circuit 122b includes the power supply control circuit 1223. That is, as illustrated in FIG. 2, the second bus IF circuit 122b includes the transaction buffer 1221, the transaction control circuit 1222, and the power supply control circuit 1223.

The transaction buffer 1221 is a buffer circuit that enables pipelined processing of data transmission transactions. For example, the transaction buffer 1221 temporarily pipelines and buffers data blocks to be output from the second circuit module 15 to the bus 12 or data blocks acquired from the bus 12.

The transaction control circuit 1222 is a circuit for controlling transactions of the data blocks buffered in the transaction buffer 1221 through stage-by-stage pipelining. For example, the transaction control circuit 1222 performs control such that data blocks at each stage, output from the second circuit module 15 and buffered in the transaction buffer 1221, are sequentially output to the bus core 121. Alternatively, the transaction control circuit 1222 performs control such that data blocks at each stage, acquired from the bus core 121, are written in the transaction buffer 1221 so that the data blocks are sequentially output to the second circuit module 15. The transaction control circuit 1222 controls the power supply control circuit 1223 in accordance with a transaction state. For example, when all transactions are completed after the transaction control circuit 1222 acquires a power cutoff instruction set from the processor circuit module 13, the transaction control circuit 1222 instructs the power supply control circuit 1223 to cut off power supply to the second circuit module 15. Further, when the transaction control circuit 1222 acquires a power restoration instruction set from the processor circuit module 13, the transaction control circuit 1222 instructs the power supply control circuit 1223 to restore power supply to the second circuit module 15.

The power supply control circuit 1223 is a circuit configured to control power supply and power cutoff to the second circuit module 15 connected thereto. The power supply control circuit 1223 is configured to include a power supply control register 1224. The power supply control register 1224 is a register configured to store a rewritable value for specifying the operation and state of each switching element 1511 of the power supply switch unit 151 with respect to the second circuit module 15. That is, the operation of each switching element 1511 is controlled based on the value of the power supply control register 1224. Accordingly, by rewriting the value of the power supply control register 1224 to a given value, it is possible to flexibly switch between power supply and power cutoff to the second circuit module 15, instead of the difficulty of making changes after hardware is finalized. The register value of the power supply control register 1224 can be used to determine a predetermined output signal of the isolation cell 161 (described later).

For example, the power supply control circuit 1223 may perform control in accordance with the register value of the power supply control register 1224 such that switching elements 1511 (“first switching elements”) constituting a first group and switching elements 1511 (“second switching elements”) constituting a second group operate in parallel or at the same time. Alternatively, the power supply control circuit 1223 may perform control in accordance with the register value such that the first switching elements and the second switching elements operate sequentially with a predetermined offset time. That is, it is possible to shorten time necessary for cutoff and restoration of power supply by controlling the switching elements 1511 of the first group and the switching elements 1511 of the second group in parallel. However, in the case of such a parallel control, inrush current (transient current) may increase and induce malfunctions of adjacent circuit modules. In contrast, when the switching elements 1511 of the first group and the switching elements 1511 of the second group are controlled serially, it takes a long time for cut off and restoration of power supply, but it is possible to suppress inrush current and malfunctions of adjacent circuit modules. Accordingly, it is important to identify the optimal control point (the operation timing, the number, and the like) of the switching elements 1511 of the first group and the switching elements 1511 of the second group. In this disclosure, the optimal control point is determined during chip evaluation rather than during hardware design and maintained as the value of the power supply control register 1224, and hereby, it is possible to shorten the time for hardware design and reduce the risk of hardware design errors.

In this disclosure, the power supply control circuit 1223 performs control based on the register value of the power supply control register 1224 such that the isolation region 16 can output a bit signal represented by a predetermined alternating voltage. Such a bit signal may subdue signals from entering the second circuit module 15 during power cutoff from its surroundings and may be used to transmit predetermined information to other circuit modules adjacent thereto. For example, the power supply control circuit 1223 outputs a data control signal to the isolation region 16 so that the isolation region 16 outputs a predetermined enable signal, a predetermined clock signal, a predetermined data signal, or the like.

FIG. 3 is a view to describe power supply control for the second circuit module by the bus interface circuit in the semiconductor integrated circuit device according to one embodiment of the present invention. More specifically, FIG. 3 illustrates the power supply switch units 151 in the second circuit module 15 and the power supply control circuit 1223 for controlling the power supply switch units 151. The number of power supply switch units 151 depends on the scale of the circuit module core and therefore may be larger or smaller than the number illustrated herein.

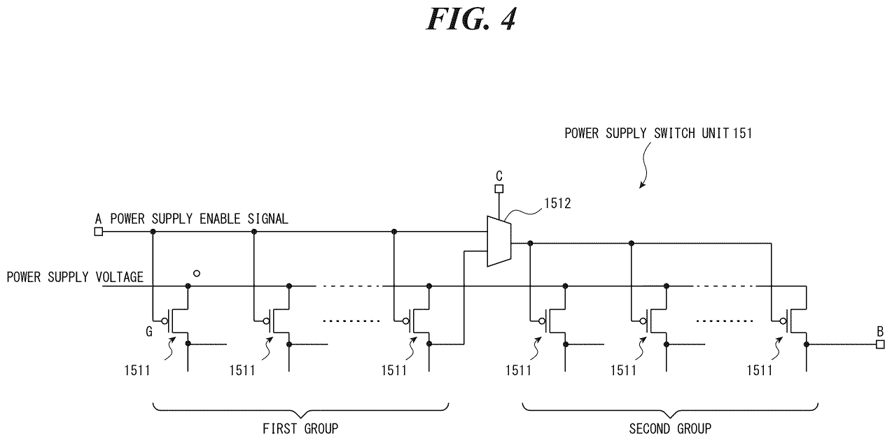

As illustrated in FIG. 3, the plurality of power supply switch units 151 is arranged around a main part (herein referred to as a “circuit module core”) of the second circuit module 15, for example. Each of the power supply switch units 151 includes a plurality of switching elements 1511 (see FIG. 4). Each of the power supply switch units 151 includes terminals A to C. The terminal B of a preceding power supply switch unit 151 is connected to the terminal A of a subsequent power supply switch unit 151, so that these power supply switch units 151 are connected in series to each other and also connected to the power supply control circuit 1223. Respective terminals C of the power supply switch units 151 are connected to the power supply control circuit 1223.

FIG. 4 is a view illustrating an exemplary configuration of the power supply switch units of the second circuit module in the semiconductor integrated circuit device according to one embodiment of the present invention. As illustrated in FIG. 4, the power supply switch unit 151 is configured to include a plurality of switching elements 1511 connected in series between the terminal A and the terminal B. The switching element 1511 is a P-channel MOSFET, for example. The gate of the switching element 1511 is connected to the terminal A, the source thereof is connected to a power supply voltage line, and the drain thereof is connected to the circuit module core (not illustrated). Accordingly, the switching element 1511 supplies a power supply voltage to the circuit module core or cuts off the power supply voltage to the circuit module core, in response to a power supply enable signal. The output of the drain of the switching element 1511 can be used as a power supply confirmation signal.

The power supply switch unit 151 includes a selector 1512 connected to the terminal C. The plurality of switching elements 1511 is divided into a plurality of groups by the selector 1512. In this example, the switching elements 1511 are divided into the first group and the second group. The groups may include the same number of switching elements 1511 or may include different numbers of switching elements 1511.

In response to a selector signal from the terminal C, the selector 1512 selects both the switching elements 1511 in the first group and the switching elements 1511 in the second group or selects the switching elements 1511 in the second group. The selector signal depends on the value of the power supply control register 1224. That is, at the stage where the semiconductor integrated circuit device 1 is actually manufactured using silicon, the power supply and cutoff operation by the grouped switching elements 1511 is evaluated, and the register value of the power supply control register 1224 is determined based on the evaluation result. For example, the register value is determined so that the first switching elements and the second switching elements operate in parallel. Alternatively, the register value is determined so that the first switching elements and the second switching elements operate sequentially with a predetermined offset time. By this configuration, it is possible to flexibly select optimal combinations of the switching elements 1511 for power supply and power cutoff to the second circuit module 15.

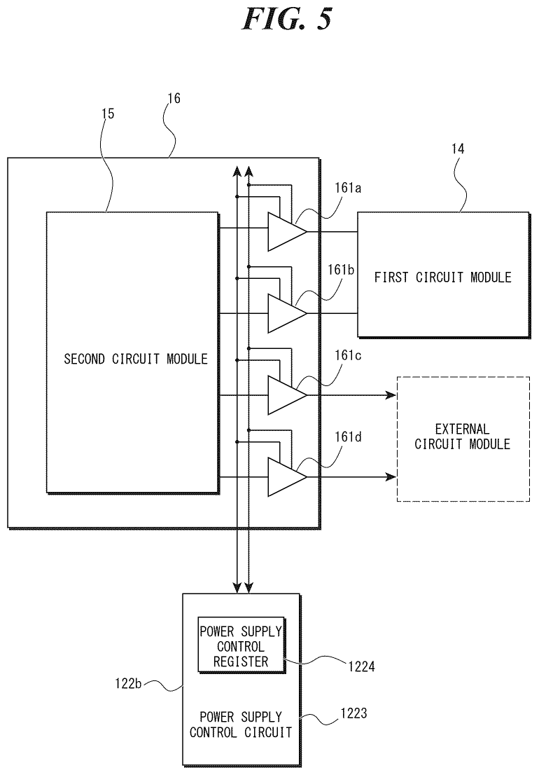

FIG. 5 is a view to describe control for an isolation region by the bus interface circuit in the semiconductor integrated circuit device according to one embodiment of the present invention. More specifically, FIG. 5 illustrates the isolation region 16 for the second circuit module 15 and the power supply control circuit 1223 for controlling the isolation region 16.

As illustrated in FIG. 5, the isolation region 16 includes several isolation cells 161. Each of the isolation cells 161 is controlled by the power supply control circuit 1223 via a power supply enable signal line for power supply and power cutoff and an output signal control line. For example, each of the isolation cells 161 may output a bit signal represented by a predetermined alternating voltage in accordance with the register value of the power supply control register 1224 under the control of the power supply control circuit 1223 while power supply to the second circuit module 15 is cut off.

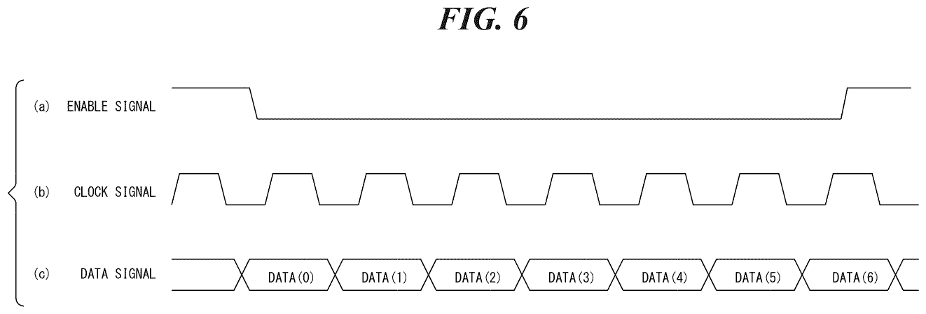

For example, isolation cells 161a and 161b may output, to the first circuit module 14, a predetermined enable signal as illustrated in FIG. 6(a) and a predetermined clock signal as illustrated in FIG. 6(b) under the control of the power supply control circuit 1223. In the meantime, isolation cells 161c and 161d may output a predetermined data signal illustrated in FIG. 6(c) to a circuit module outside the semiconductor integrated circuit device 1 under the control of the power supply control circuit 1223.

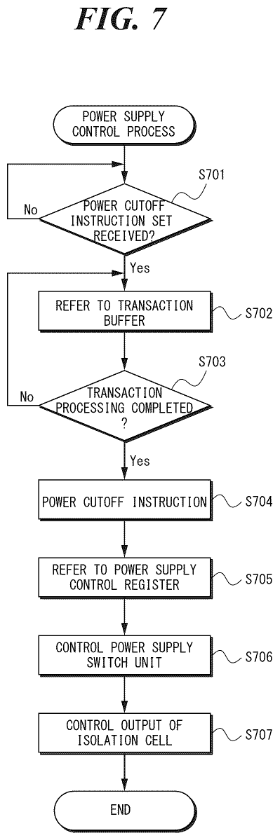

FIG. 7 is a flowchart to describe an example of the operation of the bus interface circuit in the semiconductor integrated circuit device according to one embodiment of the present invention. More specifically, FIG. 7 is a flowchart to describe an example of the operation of the bus interface circuit 122 corresponding to a given second circuit module during power cutoff.

As illustrated in FIG. 7, the transaction control circuit 1222 of the bus interface circuit 122 monitors whether or not a power cutoff instruction set is received (S701). The power cutoff instruction set is typically transmitted from the processor circuit module 13 via the bus 12. For example, the processor circuit module 13 transmits a power cutoff instruction set as part of a predetermined instruction set for the second circuit module 15 or following the instruction set via the bus 12.

In a case where the transaction control circuit 1222 determines that the power cutoff instruction set is received (Yes in S701), the transaction control circuit 1222 refers to the transaction buffer 1221 (S702) and determines whether or not transaction processing for the second circuit module 15 is completed (S703). That is, in a case where data blocks still remain in the transaction buffer 1221, the transaction control circuit 1222 determines that transaction processing is not completed (No in S703) and monitors the transaction buffer 1221 until no data block remains in the transaction buffer 1221.

In a case where the transaction control circuit 1222 determines that no data block remains in the transaction buffer 1221 and transaction processing is completed (Yes in S703), the transaction control circuit 1222 instructs the power supply control circuit 1223 to cut off power supply (S704).

When the power supply control circuit 1223 receives a power cutoff instruction from the transaction control circuit 1222, the power supply control circuit 1223 acquires a register value by referring to the power supply control register 1224 (S705). Subsequently, the power supply control circuit 1223 controls the power supply switch unit 151 based on the register value (S706). For example, the power supply control circuit 1223 controls some switching elements 1511 in each power supply switch unit 151 to be turned off, based on the register value of the power supply control register 1224. Hereby, power supply to the second circuit module 15 is cut off.

Subsequently, the power supply control circuit 1223 performs control to drive the isolation cells 161 based on the register value (S707). In this case, the power supply control circuit 1223 performs control such that the isolation cells 161 output a predetermined bit signal as illustrated in FIG. 6, for example. By this, it is possible to effectively cut off signals from entering the second circuit module 15 that stops operating, and even while the operation of the second circuit module 15 stops, it is possible to output a predetermined bit signal to other circuit modules.

As described above, with the present embodiment, even when the semiconductor integrated circuit device 1 does not include an individual power management unit (PMU) for power supply control for the second circuit module 15 (the power cutoff target circuit module), it is possible to cut off and restore power supply to the second circuit module 15 with the use of the second bus interface circuit connected to the second circuit module 15. Accordingly, no wiring line from the PMU to the power cutoff target circuit module is required unlike the related art, thereby making it possible to reduce working hours for the layout process required due to wiring congestion.

With the present embodiment, in the power supply control for the second circuit module 15 in the semiconductor integrated circuit device 1, the switching elements 1511 in several groups are controlled per particular group, thereby making it possible to suppress the influence of inrush current and to reduce adverse effects to adjacent circuit modules.

In the present embodiment, even while power supply to the second circuit module 15 in the semiconductor integrated circuit device 1 is cut off, it is possible to perform signal control for other circuit blocks with the use of the isolation cells 161.

In the present embodiment, since power supply control is determined by software (the register value) instead of hardware, it is possible to reduce man-hours for development of the semiconductor integrated circuit device 1 to which the power cutoff technology is applied and to suppress development costs incurred as a result.

The above embodiment is just an example to describe the present invention and is not intended to limit the present invention to the embodiment. The present invention can be modified variously without deviating from the gist of the present invention.

For example, in the method disclosed herein, steps, operations, or functions may be performed in parallel or in different orders as long as no inconsistency occurs in the result. The steps, operations, and functions described herein are provided merely as examples, and some of the steps, operations, and functions may be omitted, combined into a single unit, or supplemented with additional steps, operations, or functions, provided that such modifications do not depart from the gist of the invention.

The present specification discloses various embodiments, but a specific feature (technical element) of one embodiment may be appropriately modified and added to another embodiment, or substituted for a corresponding feature in another embodiment, and such variations are also encompassed within the gist of the invention.

### REFERENCE SIGNS LIST

1: semiconductor integrated circuit device
11: electrode pad
12: bus
121: bus core
122, 122a, 122b: bus interface circuit
1221: transaction buffer
1222: transaction control circuit
1223: power supply control circuit
1224: power supply control register
13: processor circuit module
14: first circuit module (continuously energized circuit module)
15: second circuit module (power cutoff target circuit module)
151: power supply switch unit
1511: switching element
1512: selector
16: isolation region
161, 161a, 161b, 161c, 161d: isolation cell

1. A semiconductor integrated circuit device comprising:
a bus;
a processor circuit module; and
a predetermined circuit module targeted for power cutoff,
wherein the bus includes
a bus core including a data signal line, and
a predetermined bus interface circuit configured to connect the predetermined circuit module to the bus core,
wherein the predetermined bus interface circuit includes
a transaction control circuit configured to control transactions for data transmission via the bus core, and
a power supply control circuit including a power supply control register and configured to perform power supply control for the predetermined circuit module in accordance with a register value stored in the power supply control register, and
wherein the power supply control circuit performs, under control of the processor circuit module, control to cut off power supply to the predetermined circuit module in response to a power cutoff instruction from the transaction control circuit.

2. The semiconductor integrated circuit device according to claim 1, further comprising a bus interface circuit different from the predetermined bus interface and configured to connect a circuit module not targeted for power cutoff to the bus core.

3. The semiconductor integrated circuit device according to claim 1, wherein the transaction control circuit provides the power cutoff instruction to the power supply control circuit in response to a power cutoff instruction set from the processor circuit module.

4. The semiconductor integrated circuit device according to claim 1, further comprising a power supply switch unit including at least one switching element configured to selectively switch between power supply and power cutoff to the predetermined circuit module.

5. The semiconductor integrated circuit device according to claim 4, wherein the power supply control circuit controls the at least one switching element to selectively switch between power supply and power cutoff in accordance with the register value.

6. The semiconductor integrated circuit device according to claim 5,
wherein the power supply switch unit includes
a plurality of switching elements as the at least one switching element, and
a selector configured to divide the plurality of switching elements into first switching elements as a first group and second switching elements as a second group.

7. The semiconductor integrated circuit device according to claim 6, wherein the power supply control circuit controls the selector in accordance with the register value such that the first switching elements and the second switching elements operate in parallel.

8. The semiconductor integrated circuit device according to claim 6, wherein the power supply control circuit controls the selector in accordance with the register value such that the first switching elements and the second switching elements operate sequentially with a predetermined offset time.

9. The semiconductor integrated circuit device according to claim 1, wherein the power supply control register is configured to rewrite the register value.

10. The semiconductor integrated circuit device according to claim 1, further comprising an isolation region provided to surround at least part of the predetermined circuit module,
wherein the isolation region includes at least one isolation cell configured to output a predetermined data signal externally under control of the power supply control circuit.

11. The semiconductor integrated circuit device according to claim 10, wherein in a case where the power supply control circuit performs control to cut off power supply to the predetermined circuit module, the power supply control circuit controls the at least one isolation cell to output the predetermined data signal in synchronization with a predetermined clock signal.

12. A power cutoff method for cutting off power supply to a predetermined circuit module targeted for power cutoff in a semiconductor integrated circuit device, the power cutoff method comprising:
receiving a power cutoff instruction set from a processor circuit module via a bus under control of a bus interface circuit configured to connect the predetermined circuit module to the bus; and
performing control to cut off power supply to the predetermined circuit module in accordance with a register value of a power supply control register, in response to completion of transaction processing for the predetermined circuit module.

13. The power cutoff method according to claim 12, further comprising:
causing, under control of the bus interface circuit, an isolation cell in an isolation region formed around the predetermined circuit module to output a predetermined output signal in accordance with the register value while cutting off the power supply.
